(19) United States
(12) Patent Application Publication
(10) Pub. No.: US 2024/0311269 A1
(43) Pub. Date: Sep. 19, 2024

(54) SIMULATOR METRICS FOR AUTONOMOUS DRIVING

(71) Applicant: Waymo LLC, Mountain View, CA (US)

(72) Inventors: Nico Montali, London (GB); Brandyn Allen White, Mountain View, CA (US); Alex Richard Kuefler, San Jose, CA (US); Paul Marie Vincent Mougin, Oxford (GB)

(21) Appl. No.: 18/603,102

(22) Filed: Mar. 12, 2024

Related U.S. Application Data
(60) Provisional application No. 63/452,135, filed on Mar. 14, 2023.

(51) Int. Cl. G06F 11/34; G06F 8/60

(52) U.S. Cl. CPC G06F 11/3457; G06F 8/60

(57) ABSTRACT

Methods, systems, and apparatus, including computer programs encoded on a computer storage medium, for selecting simulators for evaluating control software for autonomous vehicles. In one aspect, a system comprises: receiving data specifying a driving scenario in an environment; receiving an actual value of a low-level statistic measuring a corresponding property of the driving scenario; generating simulations of the driving scenario using a simulator; determining, for each simulation, a respective predicted value of the low-level statistic that measures the corresponding property of the simulation; determining, from the respective predicted values for the simulations, a likelihood assigned to the actual value of the low-level statistic by the simulations; and determining, from the likelihood, a low-level metric for the simulator and for the driving scenario that measures a realism of the simulator with respect to the corresponding property of the driving scenario.

### CROSS-REFERENCE TO RELATED APPLICATION

This application claims priority to U.S. Provisional Application No. 63/452,135, filed on Mar. 14, 2023. The disclosure of the prior application is considered part of and is incorporated by reference in the disclosure of this application.

### BACKGROUND

This specification relates to simulating driving scenarios involving agents in an environment.

The environment may be a real-world environment, and the agents may be, e.g., vehicle in the environment. For example, one of the vehicles can be an autonomous vehicle navigating through the environment while controlled by control software.

Autonomous vehicles include self-driving cars, boats, and aircraft.

### BRIEF DESCRIPTION OF THE DRAWINGS

FIG. 1 is a diagram of an example system for evaluating control software for a vehicle.

FIG. 2 is a flow diagram of an example process for evaluating simulators and control software.

FIG. 3 is a flow diagram of an example process for determining a low-level metric for a simulator.

FIG. 4 is a flow diagram of an example process for simulating a driving scenario using a simulator.

FIG. 5 illustrates an example of using a histogram to determine a likelihood for a low-level statistic.

Like reference numbers and designations in the various drawings indicate like elements.

### DETAILED DESCRIPTION

This specification describes methods and systems for selecting simulators for evaluating control software for autonomous vehicles. In particular, this specification describes methods and systems for selecting the simulators using an efficiently computable metric that measures a realism of the simulators.

The systems described in this specification can select simulators to evaluate autonomous vehicle control systems based on a high-level metric that measures how realistically the simulators reproduce real-world data from different driving scenarios. The systems described in this specification can compute the high-level metric for a simulator as a combination of multiple low-level metrics for the simulator. Each low-level metric measures how realistically the simulators reproduce individual properties of the driving scenarios (e.g., the individual properties can include the trajectories of individual agents, indications of collisions, indications of road departures, etc., during the driving scenarios).

The simulation of a navigation environment, including, e.g., the trajectories of multiple agents within the environment, is a high-dimensional prediction task. Exactly evaluating the realism of a simulator in reproducing driving scenarios requires evaluating how well the simulator reproduces a combination of a large number of individual, low-level properties of the driving scenario. Due to the high-dimensionality of navigation environments, it can be computationally infeasible to accurately evaluate, e.g., joint likelihoods of combinations of low-level properties according to driving scenario simulators.

Conventional methods for evaluating driving scenario simulators that exactly evaluate simulator realism (e.g., by estimating joint likelihoods of low-level properties according to the simulators) require very large amounts of training data to accurately evaluate the simulators. Conventional methods that reduce the computational burden of evaluating simulator realism based only on how well the simulators reproduce a single low-level property (e.g., by estimating the marginal likelihoods of the low-level properties according to the simulator) cannot fully measure an overall realism of the simulators. By evaluating simulator realism based on a high-level metric computed as a combination of multiple low-level metrics, the described systems are able to evaluate an overall realism for the simulators while only requiring as much data as is needed to accurately evaluate the low-level metrics. The described systems can therefore accurately and computationally efficiently determine the realism for driving scenario simulators.

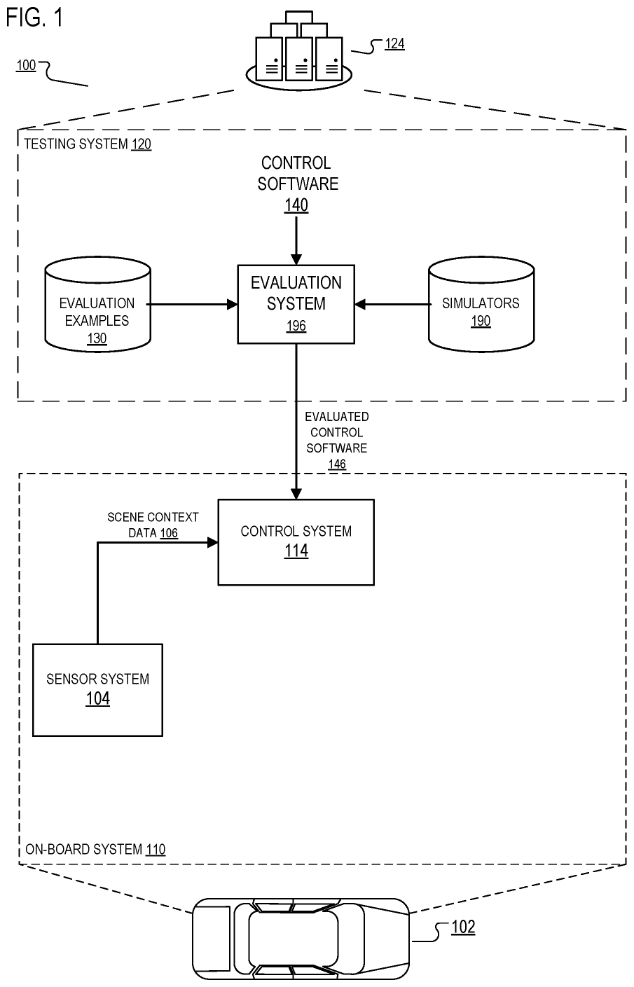

FIG. 1 is a diagram of an example system 100 for evaluating control software 140 for a vehicle 102. The system 100 includes an on-board system 110 for the vehicle 102 that tracks objects in an environment around the vehicle 102.

The on-board system 110 is located on-board the vehicle 102. The vehicle 102 in FIG. 1 is illustrated as an automobile, but the on-board system 110 can be located on-board any appropriate vehicle type.

In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 102 can alert the driver of the vehicle 102 or take an autonomous driving action when an obstacle is detected, when the vehicle departs from a driving lane, or when an object is detected in a blind spot of the human driver.

The on-board system 110 includes a sensor system 104 which enables the on-board system 110 to “see” the environment in the vicinity of the vehicle 102. More specifically, the sensor system 104 includes one or more sensors, some of which are configured to receive reflections of electromagnetic radiation from the environment in the vicinity of the vehicle 102. For example, the sensor system 104 can include one or more laser sensors (e.g., LIDAR laser sensors) that are configured to detect reflections of laser light. As another example, the sensor system 104 can include one or more radar sensors that are configured to detect reflections of radio waves. As another example, the sensor system 104 can include one or more camera sensors that are configured to detect reflections of visible light.

The sensor system 104 continually (i.e., at each of multiple time points) captures raw sensor data, which can indicate the directions, intensities, and distances travelled by reflected radiation. For example, a sensor in the sensor system 104 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The on-board system 110 can process the raw sensor data to generate scene context data 106.

The scene context data 106 characterizes a scene in an environment, e.g., an area of the environment that includes the area within a threshold distance of the autonomous vehicle or the area that is within range of at least one sensor of the vehicle.

Generally, the scene context data 106 includes multiple modalities of features that describe the scene in the environment. A modality, as used in this specification, refers to a feature that provides a particular type of information about the environment. Thus, different modalities provide different types of information about the environment. For example, the scene context data 106 can include features from the following modalities: a traffic light state modality that provides information about a traffic light state of traffic lights in the environment, a road graph data modality that provides static information about the roadways in the environment, an agent history modality that provides information about the current and previous positions of agents in the environment, and an agent interaction modality that provides information about interactions between agents in the environment.

In some examples, the context data 106 includes raw sensor data generated by one or more sensors from the sensor system 104.

The on-board system includes a control system 114. The control system 114 can use the scene context data 106 to control the vehicle 102, to assist a human driver that is controlling the vehicle 102, or both.

In particular, the control system 114 can include a variety of control software. Some examples of control software include machine learning models and hard-coded software models that process the scene context data 106 including, e.g., object detection models that detect and classify objects in the environment, behavior prediction models that predict the future behavior of other agents in the environment, planning models that can plan a future trajectory of the vehicle 102 using the behavior predictions and the object detection predictions, and so on. The planning models can make autonomous or semi-autonomous driving decisions for the vehicle 102, e.g., by generating a planned vehicle path that characterizes a path that the vehicle 102 will take in the future.

The system 100 includes a testing system 120 that can evaluate the control software 140 before the control software 140 is used on-board the vehicle 102. Generally, evaluating control software 140 can involve training a machine learning model, testing the performance of a trained machine learning model or a hard-coded piece of software, and so on.

The testing system 120 is typically hosted within a data center 124, which can be a distributed computing system having hundreds or thousands of computers in one or more locations.

The testing system 120 can evaluate the control software 140 for the control system 114 using evaluation examples 130 of the system 120. The evaluation examples 130 generally includes example scene context data 106. The evaluation examples 130 may be obtained from real or simulated driving data logs of driving scenarios encountered in the environment. A “driving scenario” is a segment of time during which the vehicle 102 or a different vehicle navigates through the real-world environment and the data for the log can include sensor data or processed sensor data characterizing the segment of time at each of multiple time points during the segment. For example, the log data for a given scenario can include raw sensor readings at multiple time points during the time segment, processed sensor data that characterizes trajectories of agents across the time segment as determined from the raw sensor readings or other data, or both. The log data can also include other information, e.g., data indicating the environmental conditions, e.g., weather, time of day, and so on, during the time segment, data including map information for roads in the vicinity of the real-world region where the scenario occurred and so on.

The testing system 120 also maintains a plurality of simulators 190. Each simulator is software that can simulate the dynamics of driving scenarios. That is, given an initial state of a driving scenario, the simulators 190 can model the successive states of the environment and the actions of vehicles in the environment, e.g., the driving actions of vehicles in the environment, the movements of pedestrians and cyclists in the environment, and so on. In some cases, a target agent within the simulation, e.g., that corresponds to a simulated version of the autonomous vehicle 102, can be controlled by the control software 140 that is being evaluated while the other agents are controlled by the simulator 190.

Generally, real-world driving scenarios are stochastic. That is, different outcomes will generally be observed in the real-world given the same initial conditions of a scenario. Therefore, the simulators 190 maintained by the testing system 120 are also stochastic and can generate different simulations of a given driving scenario starting from the same initial conditions.

The system 120 can maintain any appropriate simulator 190 that is stochastic, i.e., that can generate different simulated driving scenarios given the same initial state. For example, a simulator of the system 120 can be a machine learning model for trajectory prediction. Example simulators 190 include: Symphony simulators as described by Igl, et al. in “Symphony: Learning Realistic and Diverse Agents for Autonomous Driving Simulation”, Wayformer motion prediction models as described by Nayakanti et al. in “Wayformer: Motion Forecasting via Simple & Efficient Attention Networks”, Multiverse Transformers for agent simulation as described by Wang et al. in “Multiverse Transformer: 1st Place Solution for Waymo Open Sim Agents Challenge 2023”, Motion Transformers as described by Shi et al. in “MTR-A: 1st Place Solution for 2022 Waymo Open Dataset Challenge—Motion Prediction”.

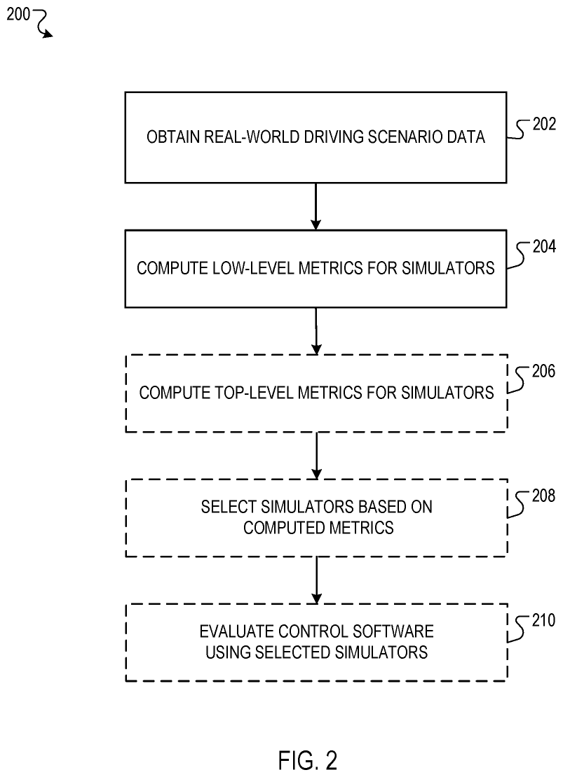

The training engine 142 includes an evaluation system 196 that can evaluate the performance of the simulators 190. In particular, the system 196 can compute an evaluation metric that measures a realism of the simulators. The evaluation metric can measure the realism of the simulators 190 by, e.g., computing a likelihood of the simulators 190 reproducing driving scenarios from the evaluation examples 130. Computing the metric is described in more detail below with reference to FIG. 2.

The evaluation system 196 can evaluate control software 140 for the control system 114 using one or more simulators 190 maintained by the testing system 120. For example, the evaluation system 196 can use a given simulator 190 to simulate the operation of the control software 140 for different simulated driving scenarios and can evaluate the performance of the control software 140 (e.g., as measured by performance metrics for the control software) for the different simulated driving scenarios.

The system 120 can select, based on the realism of the simulators 190 determined by the evaluation system 196, one or more of the simulators 190 to use for evaluating the control software 140. The system 120 can use the selected simulators to evaluate the control software 140 to determine whether the control software 140 is suitable for deployment on-board the vehicle 102.

After evaluating the control software 140 for the control system 114, the training system 122 can send the evaluated control software 146 to the control system 114, e.g., through a wired or wireless connection.

FIG. 2 is a flow diagram of an example process 200 for evaluating simulators and control software. For convenience, the process 200 will be described as being performed by a system of one or more computers located in one or more locations. For example, an evaluation system, e.g., the evaluation system 196 of FIG. 1, appropriately programmed in accordance with this specification, can perform the process 200.

The system obtains real-world driving scenario data for a plurality of real-world driving scenarios (step 202).

As described above, each real-world driving scenario is a segment of time during which one or more agents navigate through the real-world environment. The real-world driving scenario data can include data specifying the real-world driving scenarios, e.g., data characterizing initial states (e.g., initial locations, velocities, control inputs, planned trajectories, etc.) of agents for the driving scenarios, data characterizing trajectories of agents during the driving scenarios (e.g., locations of the agents at one or more time points of the driving scenarios), data indicating the environmental conditions (e.g., weather, time of day, etc.) during the driving scenarios, data including map information for the environments of the driving scenarios, and so on.

For each real-world driving scenario, the real-world data can include actual values (e.g., ground truth values, for example, as obtained by sensors within the real-world environment, as determined based on observed agent trajectories through the real-world environment, etc.) for one or more low-level statistics for the driving scenario. The low-level statistics for the driving scenarios can be any of a variety of statistics that measure different properties of the driving scenarios. For example, each low-level statistic can measure one or more properties of the motion of one or more target agents for the low-level statistic, e.g., the autonomous vehicle or another agent in the scenario.

For example, a low-level statistic can indicate whether a collision occurred during the scenario between two target agents for the low-level statistic.

As another example a low-level statistic can indicate whether a target agent for the low-level statistic went off-road during the scenario.

As another example, a low-level statistic can measure a smallest distance between a target agent for the low-level statistic and other objects during the scenario.

As another example, a low-level statistic can measure, for one or more time points of the driving scenario, a distance, e.g., a signed distance, between a road edge and a target agent for the low-level statistic.

As another example, a low-level statistic can measure, for one or more time points of the driving scenario, motion parameters, e.g., speed, velocity, acceleration, of a target agent for the low-level statistic.

As another example, a low-level statistic can measure, for one or more time points of the driving scenario, an expected time-to-collision of the target agent for the low-level statistic, e.g., a time for the target agent to collide with another object, assuming the target agent does not change trajectory.

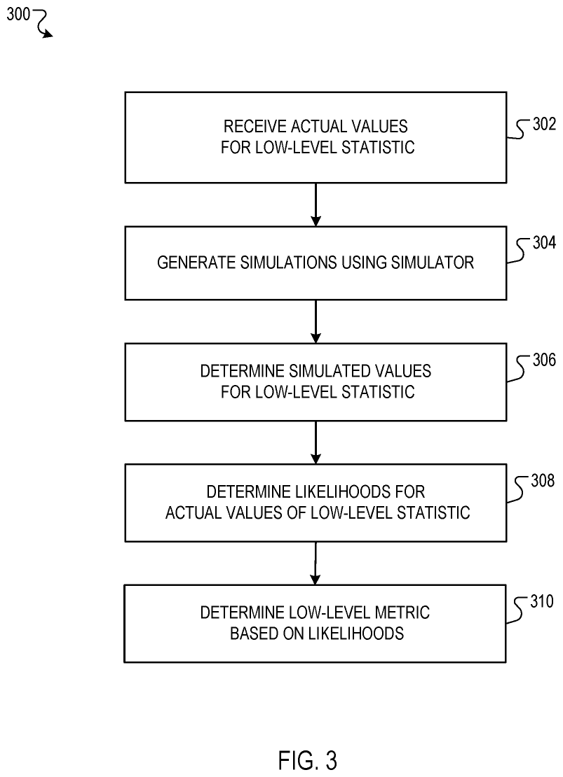

The system computes low-level metrics for each of the evaluated simulators (step 204). In particular, for each low-level statistic, the system computes a corresponding low-level metric that measures, for a given simulator, a realism of the given simulator with respect to the corresponding driving scenario property for the low-level statistic. For example, for each low-level statistic, the system computes a corresponding low-level metric that measures, for a given simulator, a similarity between (i) predicted values of the low-level statistic from simulations of the real-world driving scenarios as generated by the simulator and (ii) the actual values for the low-level statistics for the driving scenarios. As a further example, the low-level metric for a low-level statistic and a simulator can be a likelihood of the actual values of the low-level statistic according to the simulator. An example process for computing a low-level metric for a simulator is described in more detail below with reference to FIG. 3.

As part of computing the low-level metrics for the evaluated simulators, the system can generate simulations of the real-world driving scenarios using the simulators to determine predicted values of the low-level statistics. When the system determines multiple low-level metrics for a given simulator, the system can generate a set of simulations using the given simulator and compute the multiple low-level metrics based on the same generated set of simulations.

The system can compute a high-level metric for each of the evaluated simulators based on the computed low-level metrics (step 206). In particular, the high-level metric for a given simulator measures an overall realism of the given simulator. For example, the high-level metric for a given simulator measures a similarity between (i) the predicted values of the each of the low-level statistics from simulations of the real-world driving scenarios as generated by the simulator and (ii) the actual values for each of the low-level statistics for the driving scenarios. As a further example, the high-level metric for a given simulator can measure a likelihood of the real-world driving scenario data according to the simulator.

The system can compute the high-level metric value for a given simulator by combining the low-level metric values for the given simulator across the driving scenarios and the low-level statistics. For example, when the low-level metrics are likelihoods of the corresponding low-level statistics according to the simulators, the high-level metric (HLM) for a simulator, s, can be determined following:

$$HLM ( {p}_{s} ) = \frac{1}{NM} {\sum }_{i = 1}^{N} {\sum }_{j = 1}^{M} {w}_{i} log {p}_{s} ( {y}_{i , j} \vert {x}_{j} )$$

Where N is the number of low-level statistics, M is the number of driving scenarios, wᵢ is a weighting factor for the i-th low-level statistic, and pₛ(y_{i,j}|xⱼ) is the likelihood (e.g., computed low-level metric) for the actual value of the i-th low-level statistic given the conditioning information, xⱼ, for the j-th driving scenario.

The weighting factors, wi, can be normalized such that Σᵢwᵢ=1. The weighting factors can be determined to prioritize performance of the simulators with respect to particular low-level statistics. For example, to prioritize safety, the weighting factors for low-level metrics associated with statistics indicating collisions and road departures of agents can be increased (e.g., multiplied by any appropriate factor, such as by 1.5, 2, 10, and so on) relative to other low-level metrics.

By evaluating the high-level metric as a combination of individual low-level metrics, the system is able to efficiently measure the realism of the simulators while avoiding measuring dependencies between the low-level statistics. For example, evaluating the simulators based on a joint-likelihood of the low-level statistics (e.g., pₛ(y_{1,j}, . . . , y_{N,j}|xⱼ)) requires calculating the joint-likelihood based on dependencies among all of the low-level statistics. Due to the high-dimensionality of driving scenarios, accurately determining the joint-likelihood for the simulators can therefore require processing a computationally intractable amount of data (e.g., an amount of data as required to evaluate likelihoods for every individual combination of values for the low-level statistics). By evaluating the high-level metric as a combination of individual low-level metrics, the system can accurately determine the high-level metric while processing far less data (e.g., an amount of data as required to evaluate likelihoods for individual values for each of the low-level statistics).

Additionally, by combining individual low-level metrics, the high-level metric remains more interpretable by users of the system, as contributions to the high-level metric can be isolated to particular low-level metrics.

The system can then select one or more simulators for use in evaluating the control software (step 208).

In particular, the system can select the simulators by ranking the simulators based on the high-level metrics.

For example, the system can select the highest-ranked simulator.

As another example, the system can select the highest-ranked simulator so long as the highest-ranked simulator has a high-level metric score that satisfies a threshold.

As yet another example, the system can select the highest-ranked simulator so long as the highest-ranked simulator has a particular low-level metric score that satisfies a threshold. For example, to prioritize safety, the system can select simulators that satisfy threshold scores for low-level metrics associated with low-level statistics that indicate collisions and road departures of agents.

The system can then evaluate the control software using the selected simulators (step 210).

For example, the system can use the selected simulators to simulate the operation of the control software for different simulated driving scenarios and can evaluate the performance of the control software (e.g., as measured by performance metrics for the control software) for the different simulated driving scenarios.

As a further example, the system can use the selected simulators to determine whether the control software is suitable for deployment on-board a vehicle. In particular, if the system determines that the control software is suitable for deployment, the system can deploy (e.g., send to a control system of the vehicle) the evaluated control software for use in controlling the vehicle.

FIG. 3 is a flow diagram of an example process 300 for determining a low-level metric value for a given simulator and for a given driving scenario. For convenience, the process 300 will be described as being performed by a system of one or more computers located in one or more locations. For example, an evaluation system, e.g., the evaluation system 196 of FIG. 1, appropriately programmed in accordance with this specification, can perform the process 300.

The given driving scenario is a real-world scenario that occurred in the real-world environment, i.e., a time segment during which a target vehicle was navigating through the real-world environment. The low-level metric value estimates the realism of the given simulator with respect to a property measured by the low-level statistic.

The system receives an actual value of the low-level statistic for the given driving scenario (step 302).

The system generates, using the simulator, a plurality of simulations of the given driving scenario (step 304).

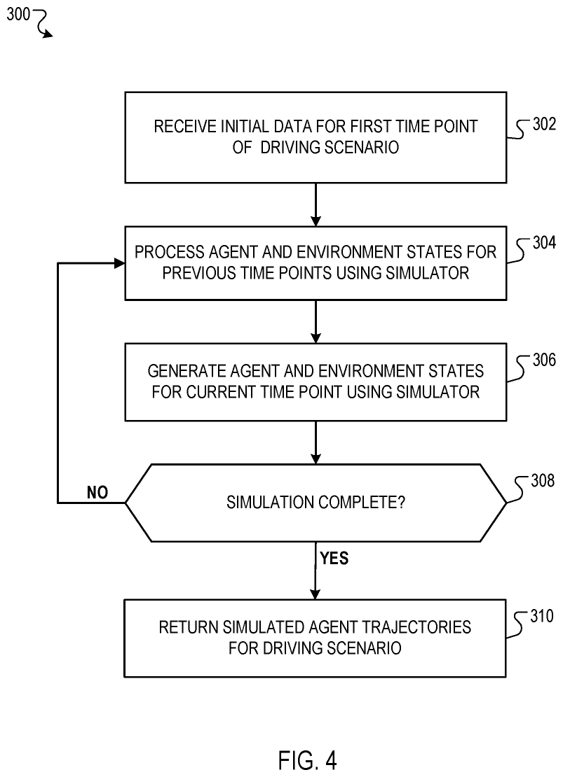

That is, the system uses the same simulator to generate multiple different simulations of the given driving scenario, i.e., that start from the initial state of the driving scenario. Optionally, in each simulation, the system can require that the target agent in the simulated scenario perform the same sequence of action as in the given real-world driving scenario. An example process of generating a simulation of a driving scenario using a simulator is described in more detail below with reference to FIG. 4.

As described above, when the system determines multiple low-level metrics for a given simulator, the system can generate a set of simulations using the given simulator and compute each of the multiple low-level metrics based on the same generated set of simulations.

The system determines a respective simulated value for the low-level statistic for each of the plurality of simulations (step 306). In particular, the system can determine the simulated values for the low-level statistic based on simulated agent trajectories from the simulations. For example, values for low-level statistics associated with agent states can include data from the simulated agent trajectories (e.g., simulated agent positions, velocities, etc.). As another example, values for other low-level statistics can be determined based on, e.g., simulated distances between agents in the simulations, simulated distances between agents and environment objects in the simulations, and so on.

The system determines a likelihood, e.g., a probability or other score representing the likelihood, assigned to the low-level statistic by a distribution over the respective simulated values for the low-level statistic for the plurality of simulations (step 308).

That is, the system can determine, from the respective simulated values for the low-level statistic, a likelihood over values, or over ranges of values, of the low-level statistic. The system can then assign, to the actual value, a likelihood using the distribution.

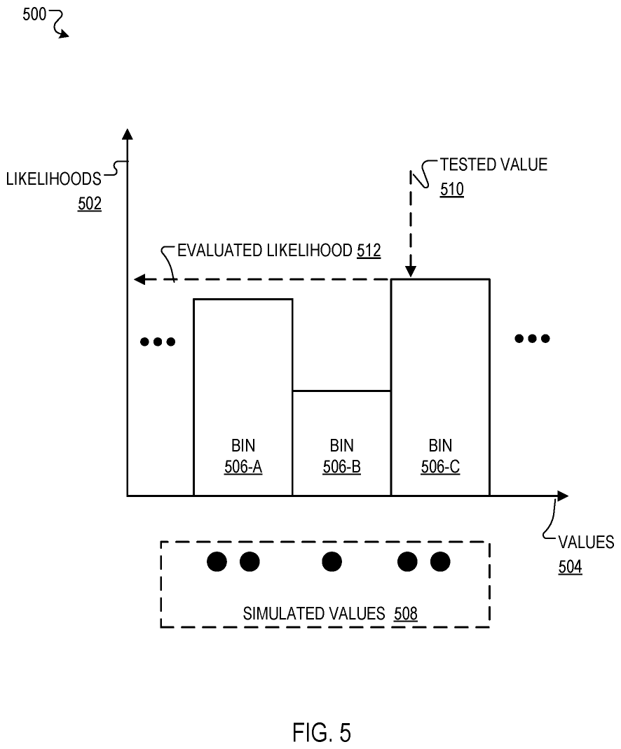

For example, the system can compute a histogram over the respective simulated values for the low-level statistic that includes a respective probability for each of multiple bins of values. The system can then assign, as the likelihood for the actual value, the probability for the bin to which the actual value belongs. An example of using a histogram to determine the likelihood is described in more detail below with reference to FIG. 5.

As another example, the system can estimate the likelihood for the actual value based on the simulated values using a density estimation technique (e.g., kernel density estimation).

The system can then determine the value of the low-level metric for the given simulator and for the given driving scenario from the likelihood (step 310). For example, the metric value can be equal to the likelihood or can be equal to the logarithm of the likelihood.

FIG. 4 is a flow diagram of an example process 400 for simulating a driving scenario using a simulator. For convenience, the process 400 will be described as being performed by a system of one or more computers located in one or more locations. For example, a simulator, e.g., one or the simulators 190 of FIG. 1, appropriately programmed in accordance with this specification, can perform the process 400.

The simulator can determine initial data for the first time point of the driving scenario (step 402). For example, the initial data for the driving scenario can include initial states (e.g., positions, velocities, control inputs, planned trajectories, etc.) for the agents of the driving scenario. As another example, the initial data for the for the driving scenario can include states for the agents of the driving scenario at for a sequence of time points before the simulated driving scenario.

The simulator can then simulate the driving scenario over a sequence of time points, following the steps described below.

At each time step, the simulator can process agent and environment states from previous time point (step 404). In particular, the system can process the previous agent and environment states to determine likelihood scores for agent motions for the current time point. For example, at the t-th time point, the system can determine a joint distribution of agent states for the t-th time step as conditioned on previous agent and environment states:

$$\\ {π}_{S} ( {\vec{a}}_{1 , t} , … , {\vec{a}}_{L , t} \vert {\vec{a}}_{1 , < t} , … , {\vec{a}}_{L , < t} , {E}_{\leq t} )$$

Where L is the number of agents in the simulated driving scenario, \vec{d}_{i,t} denotes the state of the i-th agent at the t-th time point, \vec{d}_{i,<t} denotes the states of the i-th agent at previous time points, and E_{≤t} denotes the states of the environment at previous time points.

The simulator can then generate agent and environment states for the current time point (step 406). For example, the system can sample agent states for the current time point, \vec{d}_{1,t}, . . . , \vec{d}_{L,t}, according to the determined joint distribution:

$$\\ {\vec{a}}_{1 , t} , … , {\vec{a}}_{L , t} , \sim {π}_{S} ( {\vec{a}}_{1 , t} , … , {\vec{a}}_{L , t} \vert {\vec{a}}_{1 , < t} , … , {\vec{a}}_{L , < t} , {E}_{\leq t} )$$

At each time step, the simulator can determine whether the simulation is complete (step 408). The simulator can determine whether the simulation is complete based on any appropriate stopping criteria. For example, the simulator can determine that the simulation is complete after simulating a pre-determined number of time point. As another example, the simulator can determine that the simulation is complete when a navigation task is completed in the simulation (e.g., when a target agent reaches a target location within the simulation). If the simulator determines that the simulation is not complete, the simulator can continue to generate agent and environment states for a next time step using the simulator (e.g., return to step 404 for the next time step).

When the simulator determines that the simulation is complete, the simulator can return the simulated agent trajectories for the driving scenario (step 410).

FIG. 5 illustrates an example of using a histogram 500 to determine a likelihood for a low-level statistic.

The histogram 500 specifies likelihoods 102 for values 104 of the low-level statistic. In particular, the histogram 500 specifies the likelihoods 102 for multiple bins (e.g., bins 106-A, 106-B, and 106-C) that each specify a respective likelihood 102 for a range of the values 104 associated with the bin.

For illustrative purposes, the histogram 500 is shown as a histogram for one-dimensional values of the low-level statistic. Higher dimensional histograms can be similarly constructed that include bins specifying likelihoods for associated combinations of ranges of values for multiple low-level statistics.

The likelihoods 102 for the bins of the histogram 500 are determined based on simulated values 108 of the low-level statistic. In particular, the likelihood for a bin of the histogram 500 can be determined based on the number of simulated values 108 that fall within the range of values associated with the bin.

When determining the likelihood of a tested value 110 of the low-level statistic, the evaluated likelihood 112 can be the likelihood for the bin of the histogram associated with a range of the values 104 that includes the tested value 110. For example, as illustrated, the tested value 110 falls within the range of the values 104 associated with the bin 106-C, and the evaluated likelihood 112 for the tested value 110 is the likelihood for the bin 106-C.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving data specifying a real-world driving scenario in a real-world environment;
receiving an actual value of a low-level statistic that measures a corresponding property of the real-world driving scenario;
generating, using a first simulator, a plurality of simulations of the real-world driving scenario;
determining, for each of the plurality of simulations of the real-world driving scenario, a respective predicted value of the low-level statistic that measures the corresponding property of the simulation;
determining, from the respective predicted values for the plurality of simulations, a likelihood assigned to the actual value of the low-level statistic by the plurality of simulations; and
determining, from the likelihood, a low-level metric for the first simulator and for the real-world driving scenario that measures a realism of the first simulator with respect to the corresponding property of the real-world driving scenario.

2. The method of claim 1, further comprising:
determining, based at least in part on the low-level metric, whether to use the simulator to evaluate control software for an autonomous vehicle that navigates through the real-world environment.

3. The method of claim 2, further comprising:
in response to determining to use the simulator to evaluate control software for an autonomous vehicle that navigates through the real-world environment:
evaluating the control software using the simulator to determine whether the control software is suitable for deployment on-board the autonomous vehicle, and
in response to determining that the control software is suitable, deploying the control software on-board the autonomous vehicle for use in controlling the autonomous vehicle as the autonomous vehicle navigates through the real-world environment.

4. The method of claim 1, wherein the low-level metric is a logarithm of the likelihood.

5. The method of claim 1, wherein determining, from the respective predicted values for the plurality of simulations, a likelihood assigned to the actual value of the low-level statistic by the plurality of simulations comprises:
determining, using the respective predicted values, a likelihood distribution over values of the low-level statistic, and determining a likelihood assigned to the actual value by the likelihood distribution.

6. The method of claim 5, wherein determining, using the respective predicted values, a likelihood distribution over values of the low-level statistic comprises computing a histogram over the respective predicted values.

7. The method of claim 1, further comprising:
determining a high-level metric for the first simulator based at least in part on the low-level metric.

8. The method of claim 7, wherein determining the high-level metric for the first simulator comprises:
determining respective additional low-level metrics for the first simulator for each of a plurality of additional real-world driving scenarios, and
computing the high-level metric for the first simulator from the low-level metric and the respective additional low-level metrics.

9. The method of claim 7, further comprising:
determining respective high-level metrics for each of one or more second simulators.

10. The method of claim 9, further comprising:
selecting, based at least in part on the high-level metrics of the first simulator and the one or more second simulators, a simulator for use in evaluating control software for an autonomous vehicle that navigates through the real-world environment.

11. The method of claim 8, wherein a subset of the respective additional low-level metrics are computed for different low-level statistics.

12. A system comprising:
one or more computers; and
one or more storage devices storing instructions that, when executed by the one or more computers, cause the one or more computers to perform operations comprising:
receiving data specifying a real-world driving scenario in a real-world environment;
receiving an actual value of a low-level statistic that measures a corresponding property of the real-world driving scenario;
generating, using a first simulator, a plurality of simulations of the real-world driving scenario;
determining, for each of the plurality of simulations of the real-world driving scenario, a respective predicted value of the low-level statistic that measures the corresponding property of the simulation;
determining, from the respective predicted values for the plurality of simulations, a likelihood assigned to the actual value of the low-level statistic by the plurality of simulations; and
determining, from the likelihood, a low-level metric for the first simulator and for the real-world driving scenario that measures a realism of the first simulator with respect to the corresponding property of the real-world driving scenario.

13. The system of claim 12, the operations further comprising:
determining, based at least in part on the low-level metric, whether to use the simulator to evaluate control software for an autonomous vehicle that navigates through the real-world environment.

14. The system of claim 13, the operations further comprising:
in response to determining to use the simulator to evaluate control software for an autonomous vehicle that navigates through the real-world environment:
evaluating the control software using the simulator to determine whether the control software is suitable for deployment on-board the autonomous vehicle, and
in response to determining that the control software is suitable, deploying the control software on-board the autonomous vehicle for use in controlling the autonomous vehicle as the autonomous vehicle navigates through the real-world environment.

15. The system of claim 12, wherein the low-level metric is a logarithm of the likelihood.

16. The system of claim 12, wherein determining, from the respective predicted values for the plurality of simulations, a likelihood assigned to the actual value of the low-level statistic by the plurality of simulations comprises:
determining, using the respective predicted values, a likelihood distribution over values of the low-level statistic, and
determining a likelihood assigned to the actual value by the likelihood distribution.

17. The system of claim 12, the operations further comprising:
determining a high-level metric for the first simulator based at least in part on the low-level metric.

18. The system of claim 17, wherein determining the high-level metric for the first simulator comprises:
determining respective additional low-level metrics for the first simulator for each of a plurality of additional real-world driving scenarios, and
computing the high-level metric for the first simulator from the low-level metric and the respective additional low-level metrics.

19. The system of claim 17, the operations further comprising:
determining respective high-level metrics for each of one or more second simulators.

20. One or more computer-readable storage media storing instructions that when executed by one or more computers cause the one or more computers to perform operations comprising:
receiving data specifying a real-world driving scenario in a real-world environment;
receiving an actual value of a low-level statistic that measures a corresponding property of the real-world driving scenario;
generating, using a first simulator, a plurality of simulations of the real-world driving scenario;
determining, for each of the plurality of simulations of the real-world driving scenario, a respective predicted value of the low-level statistic that measures the corresponding property of the simulation;
determining, from the respective predicted values for the plurality of simulations, a likelihood assigned to the actual value of the low-level statistic by the plurality of simulations; and
determining, from the likelihood, a low-level metric for the first simulator and for the real-world driving scenario that measures a realism of the first simulator with respect to the corresponding property of the real-world driving scenario.
